(19) United States
(12) Patent Application Publication
(10) Pub. No.: US 2009/0188860 A1
(43) Pub. Date: Jul. 30, 2009

(54) Use of antimicrobials in water technology

(76) Inventors: Matthias Hofmann-Kamensky, Grenzach-Wyhlen (DE); Klaus Nussbaum, Wehr (DE)

Correspondence Address: JoAnn Villamizar;Ciba Corporation/Patent Department, 540 White Plains Road, P.O. Box 2005, Tarrytown, NY, 10591, US

(21) Appl. No.: 12/308,909

(22) PCT Filed: Jun. 25, 2007
(86) PCT No.: PCT/EP2007/056304

§ 371 Date: Dec. 29, 2008

(30) Foreign Application Priority Data
Jul. 5, 2006 (EP) 06116610.4

(51) Int. Cl. C02F 1/50; C02F 1/44

(52) U.S. Cl. 210/636

(57) ABSTRACT

The use of dihalogeno-hydroxydiphenyl ethers as antimicrobial agents in water treatment processes, such as in purification and decontamination of drinking or waste water, is claimed. Preferably the water treatment is performed in a membrane filtration system. The antimicrobial agents protect the membrane system against bacterial and/or algal decay and assist in maintaining a high efficiency of the membrane filtration process. Methods of maintaining membrane filtration efficiency using dihalogeno-hydroxydiphenylethers as well as aqueous antimicrobial rinsing liquors comprising dihalogeno-hydroxydiphenylethers are also claimed.

The present invention relates generally to the use of antimicrobials in water treatment processes, more particularly to the use of dihalogeno-hydroxydiphenylethers in water purification systems which may be exposed to bacterial contamination.

The decontamination of the devices used in water processing for preparing e.g. drinking water, process water or cooling water, or improve their quality is one of the principal embodiment of this invention.

It is known that polymers and plastics, e.g. when used as coatings on substrates can suffer from bacterial or algal decay if routinely exposed to water, dampness or moisture. Biofilms of communities of bacteria and algae can settle on the surfaces of these substrates and increase the speed of decay. The use of certain antimicrobials in air filter systems has already been proposed (AU-B-2001242108). JP-A-2003-041293 discloses a number of components including triclosan or diclosan for use as slime removers in drain outlets. Similar components have been shown to work effectively in skin disinfection (EP-A-259249), or to be fully biodegradable (Full Public report Tinosan HP100, Natl. Industrial Chemicals Notification and Assessment Scheme, Sydney, AU, Oct. 27, 2004).

In closed water systems (water purification, desalination) using e.g. plastic parts such as pipes, filters, valves or tanks can be subject to bacterial or algal colonization and biofilm formation, leading to serious damages of filter efficacy, such as membrane permeanc(flow rate), and followed by deterioration of the materials and contamination of the circuit liquids.

Other problems with said surfaces can derive from algal or bacterial biofilm formation resulting in an undesired change in their hydrodynamic properties and affecting e.g. the flow-rate in pipes, or also the trouble-free use of boats, marine or other limnological applications. It has now been found that these disadvantages can be overcome by the use of certain antimicrobial compounds of the dihalogeno-hydroxydiphenylether group, e.g. by incorporating said compounds into substrates like polymer and/or plastic coatings or optionally by rinsing the surfaces of said substrates (coatings) with rinsing liquors containing the antimicrobial compounds.

Therefore, the principal object of the present invention is the use of dihalogeno-hydroxy-diphenylether compounds as antimicrobials in water-treatment systems, such as purification and decontamination systems for processing drinking water and/or waste water. In a preferred embodiment the water processing is carried out in a membrane filtration system.

Another object of the present invention is as method of maintaining the efficiency of said water-treatment system by preserving the membrane per se and the additionally necessary devices, such as e.g. feed and discharge pipes, valves and tanks (hereinafter: the membrane or membrane filtration system) from bacterial and algal decay by treating the membrane system with halogeno-hydroxydiphenylether compounds.

Still another object of the present invention is a method of rinsing the water-treatment system with rinsing liquors comprising dihalogeno-hydroxydiphenylether compounds to protect the water-treatment system which preferably is the mentioned membrane system against bacterial and/or algal decay.

These and other objects of the present invention will be described in more detailed manner in the following.

The inventively used dihalogeno-hydroxydiphenylethers may be the known compounds of the general formula

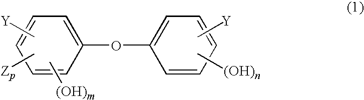

wherein
Y is chlorine or bromine,
Z is SO₂H, NO₂, C₁-C₄alkyl, C₁-C₄alkoxy, C₁-C₆alkylcarbonyl, phenyl or C₁-C₃alkyl substituted phenyl,
p is 0, 1 or 2,
m is 1 or 2 and
n is 0 or 1;
   and more especially the dichloro-2-hydroxydiphenylether of formula

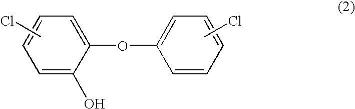

Very special preference is given to the 4,4′-dichloro-2-hydroxydiphenylether of formula

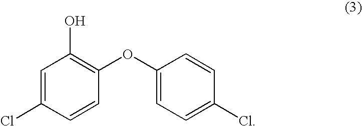

The antimicrobial agents according to formulae (1) to (3) can also be used as mixtures of two or more compounds, and they can further be combined with other antimicrobial substances to broaden the range of action and/or to achieve synergistic effects.

The action of the antimicrobial agents extends to gram-positive and gram-negative bacteria, such as of the strains Escherichia coli, Staphylococcus aureus or Pseudomonas aeruginosa, and others that may be present in aqueous environment, as well as to yeasts, dermatophytes, algae and others.

One particular embodiment of the water treatment processing wherein the dihalogeno-hydroxydiphenylethers are used is the process for the purification (desalination) and decontamination of water in a membrane system

Semipermeable membranes, mostly prepared of polymeric organic materials, may be those known for reverse osmosis, ultrafiltration, nanofiltration and/or microfiltration.

They may be cast or composite membranes and may have flat sheet or hollow fiber configuration.

Further, they may be either asymmetric or symmetric. Asymmetric membranes have pore sizes on one face of the membrane that are different from the pore size on the other face. Symmetric membranes have pore sizes that are the same on either face.

The treatment of the membrane materials (before the membrane is formed) or membranes (completed structure) with the antimicrobial dihalogeno-hydroxydiphenylethers comprises e.g. the incorporation into the membrane material or the membrane structure or into the surface (coating) of the membrane. Said incorporation includes e.g. precipitation or moulding (extrusion) processes.

The antimicrobials are generally well fixed within the polymeric material, i.e. they are as a rule non-leachable.

The membrane system comprises at least one cast semi-permeable membrane having a polymeric structure and the non-leaching antimicrobial agent incorporated into the polymeric material and dispersed throughout said material or, optionally, in a coating layer.

The polymeric material for the membranes may be selected from the group consisting of cellulose acetates, polyacrylonitriles, polyamides, polyesters, aromatic polysulfones, aromatic polyphenylenesulfones, aromatic polyethersulfones, bisphenols, polyether ketones, sulfonated polyether ketones, polyamide sulfones, polyvinylidene fluorides, polyvinylchlorides, polystyrenes and polytetrafluorethylenes or mixtures thereof.

Preferred are membranes of cellulose acetates, polyacrylonitriles, polyamide polysulfones and polyvinylidene fluorides having incorporated the non-leachable antimicrobial dihalogeno-hydroxydiphenylethers.

The membrane efficiency (e.g. the performance with regard to filtering properties or flow rates) is generally not affected by the incorporated antimicrobials which prevent bacteria from forming biofilms on their surfaces or breaching the membranes.

The concentration of the antimicrobial agent may be between about 0.01 and 2.0%, preferably 0.1 to 2.0% by weight, based on the weight of the membrane substrate.

The preparation of the semipermeable membranes comprising the antimicrobial agents is generally known in the art.

Cellulose acetate membranes are cast e.g. from a composite solution (dope solution) containing e.g. a mixture of cellulose di- and -triacetate and the antimicrobial agent in an amount as indicated above on a support (fabric). The solvent used is e.g. a dioxane/acetone mixture wherein also the antimicrobial agent is readily soluble.

They may be cast on a support (polyester fabric) and are allowed to precipitate at lower temperatures.

In the preparation of hollow fiber membranes from e.g. polyacrylonitriles polysulfones, polyether sulfones, polyether ketones, polyvinylidene fluorides or sulfonated polyvinylidene fluorides the solvents used are e.g. aprotic solvents such as dimethylformamide, dimethylsulfoxide, dimethylacetamide, N-methylpyrrolidone and mixtures thereof.

The antimicrobial agents are readily soluble in said solvents and will precipitate with the polymer when a non-solvent comes into contact with the dope solution, e.g. by passing the dope solution through a spinneret to form the hollow fiber.

Composite membranes, such as composite polyamide membranes, may be prepared by casting a dope solution of a polysulfone and antimicrobial agent onto a reinforcing fabric (polyester). When coming into contact with water, the polysulfone and the antimicrobial agent precipitate onto the reinforcing fabric and form a film. After drying this polysulfone film (membrane) is then soaked with an amine solution so that a polyamide layer is formed on the polysulfone membrane. After drying a composite membrane for reverse osmosis is obtained.

In an alternative embodiment of the present invention the membrane filtration system may be furnished with antimicrobial properties by rinsing the whole system (membranes, pipes, tanks etc.) with a rinsing liquor containing 0.01 to 2.0% of the antimicrobial agent, based on the weight of the liquor. The antimicrobial agents are normally substantive to the polymeric material of the membrane (filtration) system, and by diffusing into the top layer (e.g. coatings) of the polymeric material a long lasting protection against biofilm growth and bacterial and algal decay can be achieved.

The rinsing method is also suitable to reactivate antimicrobial activities of antimicrobially exhausted membrane filtration systems.

Preferably, the rinsing liquor, which is another object of the present invention, is an aqueous formulation containing besides the antimicrobial agent conventional components like surfactants, which may be non-ionic, anionic or zwitter-ionic compounds, sequestering agents, hydrotropes, alkali metal hydroxides (sources of alkalinity), preservative, fillers, dyes, perfumes and others.

The components and their use in rinsing liquors are well known to those skilled in the art.

The antimicrobials are very efficacious in preventing the growth of almost all kinds of bacteria present in water, do not leach out of the membrane, are safe and non-toxic to human and animal skin, and show good bio-degradability and altogether a more favorable ecological profile in the aquatic environment when compared with e.g. trichloro-hydroxydiphenylethers which are also used as antimicrobials.

The following examples will serve to illustrate the present invention but they are not limiting.

Parts and percentages are given by weight if not otherwise indicated. The temperatures are given in degrees Centigrade.

### EXAMPLE

Cellulose acetate membranes were cast from a dope solution containing about 20% of a cellulose di- and -tri-acetate mixture and 0.5% and 2.0% by weight, respectively, of the antimicrobial agent of formula (3). The solvent is a mixture of dioxane and acetone (2:1; w/w). The cast membranes are then analyzed and the results show that more than 90% of the antimicrobial agent was precipitated with the cellulose acetate polymers and was retained in the membranes.

Further, the cellulose acetate membranes were used in a reverse osmosis module in a desalination process.

The reverse osmosis module was tested to determine any bacterial presence in the permeate.

After a one month period of operation, no bacteria could be found in the permeate and on the membrane, and the flow rate and the high salt rejection (more than 96%) were not affected at all.

1-5. (canceled)

6. A method of maintaining the efficiency of a membrane water filtration system which comprises protecting said system against bacterial and/or algal decay by treating said membrane water filtration system with a dihalogeno-hydroxydiphenylether compound.

7. The method according to claim 6 wherein the treatment comprises the incorporation of the dihalogeno-hydroxydiphenylether compound into the membrane structure or optionally into its surface layer (coating).

8. The method according to claim 6 wherein the membranes are prepared from organic polymers, preferably selected from the group consisting of cellulose acetates, polyacrylonitriles, polyamides, polyesters, aromatic polysulfones, aromatic polyphenylene-sulfones, aromatic polyethersulfones, bisphenols, polyether ketones, sulfonated polyether ketones, polyamide sulfones, polyvinylidene fluorides, polyvinylchlorides, polystyrenes and polytetrafluorethylenes or mixtures thereof.

9. The method according to claim 6 wherein the dihalogeno-hydroxy-diphenylether compound is of the formula 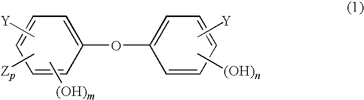
wherein
Y is chlorine or bromine,
Z is SO₂H, NO₂, C₁-C₄alkyl, C₁-C₄alkoxy, C₁-C₆alkylcarbonyl, phenyl or C₁-C₃alkyl substituted phenyl,
p is 0, 1 or 2,
m is 1 or 2 and
n is 0 or 1.

10. The method according to claim 9 wherein the dihalogeno-2-hydroxydiphenylether is of the formula

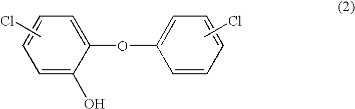

11. The method according to claim 6 wherein the treatment with the halogeno-hydroxydiphenylether compounds is carried out by incorporation of said compounds by precipitation or moulding (extrusion) into the membrane or into the surface of the membrane.

12. The method according to claim 7 wherein the amount of the dihalo-geno-hydroxydiphenylether compounds comprises 0.01 to 2.0% by weight, based on the weight of the membrane material.

13. The method according to claim 6 wherein the treatment is carried out by rinsing the membrane filtration system with aqueous rinsing liquors comprising dihalogeno-hydroxydiphenylether compounds.

14. The method according to claim 13 wherein the aqueous rinsing liquors comprise 0.01 to 2.0% by weight of the dihalogeno-hydroxydiphenylether compounds, based on the weight of the rinsing liquor.

15. A process for water treatment in a membrane filtration system, which process comprises incorporation of a dihalogeno-hydroxydiphenylether compound into the membrane and/or the step of antimicrobial treatment of the membrane filtration system with a dihalogeno-hydroxydiphenylether compound.

16-17. (canceled)

18. the method according to claim 10, wherein the dihalogeno-2-hydroxydiphenylether is of the formula

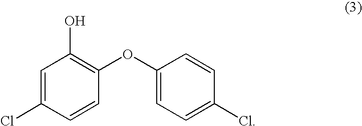

19. The method according to claim 13, wherein the dihalogeno-hydroxydiphenylether compound is of the formula 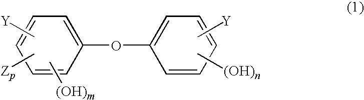
wherein
Y is chlorine or bromine,
Z is SO₂H, NO₂, C₁-C₄alkyl, C₁-C₄alkoxy, C₁-C₆alkylcarbonyl, phenyl or C₁-C₃alkyl substituted phenyl,
p is 0, 1 or 2,
m is 1 or 2 and
n is 0 or 1.

20. The method according to claim 19, wherein the dihalogeno-hydroxydiphenylether compound is of the formula (2) or (3) [chemical structure]
